(19) United States
(12) Patent Application Publication
(10) Pub. No.: US 2025/0347378 A1
(43) Pub. Date: Nov. 13, 2025

(54) DUCT HANGER FOR VIBRATION CONTROL

(71) Applicant: Sehong Co., Ltd., Yongin-si (KR)

(72) Inventor: Sung Chan KIM, Gunpo-si (KR)

(73) Assignee: Sehong Co., Ltd., Yongin-si (KR)

(21) Appl. No.: 19/200,704

(22) Filed: May 7, 2025

(30) Foreign Application Priority Data
May 8, 2024 (KR) 10-2024-0060483
Apr. 28, 2025 (KR) 10-2025-0055588

(51) Int. Cl. F16L 55/035; F16L 3/06

(52) U.S. Cl. CPC F16L 55/035; F16L 3/06

(57) ABSTRACT

Disclosed is a duct hanger for vibration control that can be consistently installed at a predetermined location and is capable of damping vibration caused by external force through a vibration damping portion, wherein the duct hanger for vibration control includes a rod coupled to the ceiling, a holder coupled to the duct, and a connector rotatably connecting the rod and the holder about a rotational axis parallel to the duct, wherein the connector includes a vibration damping portion configured to damp vibration transmitted from the rod or the holder.

### CROSS-REFERENCE TO RELATED APPLICATION

This application claims the benefit of Korean Patent Application Nos. 10-2024-0060483 filed on May 8, 2024, and 10-2025-0055588 filed on Apr. 28, 2025 in the Korean Intellectual Property Office, the entire disclosure of which is incorporated herein by reference for all purposes.

### BACKGROUND

The present invention relates to a duct hanger, and more particularly to a duct hanger for vibration control that can be uniformly installed at a predetermined location and can effectively damp vibration caused by external force.

In a typical building or facility, cables for lighting, communication, or power distribution are sometimes embedded in walls, or more often are installed in trays, conduits, ducts, chambers, or chamber-shaped structures or fixtures suspended from the ceiling to support the cables or fixtures.

Since such trays, conduits, or ducts are formed in an elongated shape and include multiple branches connected to each other, suspension members are arranged at regular intervals to ensure orderly suspension from the ceiling structure.

However, as the number of earthquakes has recently been increasing in Korea, especially in the Yeongnam region, for example, a 4.0-magnitude earthquake occurred in Uljin-gun, Gyeongbuk, on Apr. 22, 2019, a 3.9-magnitude earthquake occurred in Sangju, Gyeongbuk, on Jul. 21, 2019, a 3.4-magnitude earthquake occurred in Changnyeong-gun, Gyeongnam, on Oct. 27, 2019, and the like, there is an increasing need for a structure capable of coping with earthquakes.

In particular, since ceiling lighting fixtures, such as luminaires, are suspended a certain length from the ceiling structure instead of being firmly attached to the ceiling structure, the ceiling lighting fixtures can be easily damaged in the event of an earthquake, unless the ceiling lighting fixtures have a certain level of strength and shock absorption.

Since trays or conduits for communication or raceways for luminaires may be provided with power supplies and light emitting devices, such as LEDs, damage caused by earthquake vibration can lead to an accident, such as short circuit or electric leakage, and there is a risk of electric shock due to breakdown of connections between structures due to vibration. Thus, it is necessary to minimize the effects of earthquake vibration.

In addition, since luminaires installed to illuminate a large indoor area, such as raceways and the like, have an elongated shape, it is necessary to prevent the luminaire from bouncing horizontally in the event of an earthquake. In order to minimize damage to the luminaires, it is necessary to prevent the luminaire from bouncing while damping vibration transmitted from the outside.

However, technology for seismic means capable of maintaining stable installation of suspended structures, such as trays and conduits for communication or raceways for luminaires, are not fully developed in the art.

### RELATED LITERATURE

### Patent Document

Korean Patent Laid-open Publication No. 10-2022-0129244 published on Sep. 23, 2022

### SUMMARY

Embodiments of the present invention are conceived to solve such problems in the art and it is an object of the present invention to provide a duct hanger for vibration control that can be consistently installed at a predetermined location and is capable of damping vibration caused by external force through a vibration damping portion.

It will be understood that objects of the present invention are not limited to the aforementioned object, and the above and other objects of the present invention will become apparent to a person having ordinary knowledge in the art from the detailed description of the following embodiments in conjunction with the accompanying drawings.

In accordance with one aspect of the present invention, a duct hanger for vibration control includes: a rod coupled to the ceiling; a holder coupled to the duct; and a connector rotatably connecting the rod and the holder about a rotational axis parallel to the duct, wherein the connector includes a vibration damping portion configured to damp vibration transmitted from the rod or the holder.

In one embodiment, the connector may include: a connection member rotatably coupled to a boss of the holder about the rotational axis; and an adjuster connecting the connection member and the rod and screwed to the rod to allow an installation height of the connection member to be adjusted.

In one embodiment, the connection member may include a connection member top plate rotatably coupled to the adjuster about a vertical axis passing through a center of the rod and a connection member side plate extending from the connection member top plate toward the boss and rotatably coupled to the boss about the rotational axis.

In one embodiment, the connection member top plate may have a coupling hole into which an undercut formed on the adjuster is press-fitted.

In one embodiment, the connection member side plate may include: a first connection member side plate extending from one side of the connection member top plate toward one side of the boss and having a through-hole coaxial with a shaft hole formed in the boss; and a second connection member side plate extending from the other side of the connection member top plate toward the other side of the boss and having a fastening hole coaxial with the shaft hole formed in the boss.

In one embodiment, the vibration damping portion may include: a shaft member forming the rotational axis; a friction member movably coupled to the shaft member in a longitudinal direction of the shaft member and having a friction surface facing a contact surface of the boss formed on the holder; and an elastic member elastically pressing the friction member towards the boss such that the friction surface is brought into close contact with the contact surface.

In one embodiment, the vibration damping portion may include: a shaft member forming the rotational axis and having a threaded portion at one end thereof, the threaded portion being screwed to the fastening hole after passing through the through-hole and the shaft hole; a head coupled to the other end of the shaft member; a first friction member movably coupled to the shaft member in a longitudinal direction of the shaft member and having a first friction surface facing the contact surface of the boss; and an elastic member coupled to the shaft member to be disposed between the head and the first friction member, the elastic member elastically pressing the first friction member toward the boss such that the first friction surface is brought into close contact with the contact surface, wherein friction force between the contact surface and the first friction surface varies depending on a degree of screw engagement between the threaded portion and the fastening hole.

In one embodiment, the vibration damping portion may further include a second friction member movably coupled to the shaft member in the longitudinal direction of the shaft member between the head and the elastic member and having a second friction surface facing the contact surface of the head.

Embodiments of the present invention provide a duct hanger for vibration control that can be consistently installed at a predetermined location and is capable of effectively damping vibration caused by external force through a connection member configured to rotatably connect a rod and a holder and including a vibration damping portion.

It will be understood that advantageous effects of the present invention are not limited to the above effects, and the above and other advantageous effects of the present invention will become apparent to those skilled in the art from the detailed description of the following embodiments in conjunction with the accompanying drawing.

### DRAWINGS

The above and other aspects, features, and advantages of the present invention will become apparent from the detailed description of the following embodiments in conjunction with the accompanying drawings.

FIG. 1 is a perspective view of a duct hanger for vibration control according to one embodiment of the present invention.

FIG. 2 is a front view of the duct hanger shown in FIG. 1.

FIG. 3 is an exploded perspective view of a holder shown in FIG. 1.

FIG. 4 is side sectional views of a holding clip in operation.

FIG. 5 is a partially exploded perspective view of the duct hanger shown in FIG. 1.

FIG. 6 is an exploded sectional view of the duct hanger shown in FIG. 5.

FIG. 7 is a side sectional view of the duct hanger shown in FIG. 6 in a coupled state.

FIG. 8 is a partially exploded view of the duct hanger shown in FIG. 5.

FIG. 9 is a perspective view of a duct hanger for vibration control according to another embodiment of the present invention.

FIG. 10 is a front view of the duct hanger shown in FIG. 9.

FIG. 11 is a plan view of a holder shown in FIG. 9.

FIG. 12 is an exploded perspective view of the duct hanger shown in FIG. 9.

FIG. 13 is a perspective view and a bottom view of a boss shown in FIG. 9.

FIG. 14 is a front view and a rear view of a first connection member shown in FIG. 12.

FIG. 15 is a front view and a rear view of a second connection member shown in FIG. 12.

FIG. 16 is a view of a vibration damping portion in a coupled state shown in FIG. 12.

### DETAILED DESCRIPTION

Hereinafter, exemplary embodiments of the present invention will be described in detail with reference to the accompanying drawings. It should be understood that the present invention may be embodied in different ways and is not limited to the following embodiments. In the drawings, portions irrelevant to the description will be omitted for clarity. Like components will be denoted by like reference numerals throughout the specification.

Throughout the specification, when an element or layer is referred to as being “on”, “connected to”, or “coupled to” another element or layer, it may be directly on, connected to, or coupled to the other element or layer or intervening elements or layers may be present. In addition, unless stated otherwise, the term “includes” should be interpreted as not excluding the presence of other components than those listed herein.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises”, “comprising”, “includes”, and/or “including” when used in this specification, specify the presence of stated features, integers, steps, operations, elements, components, and/or groups thereof, but do not preclude the presence or addition of one or more other features, integers, steps, operations, elements, components, and/or groups thereof.

Hereinafter, embodiments of the present invention will be described with reference to the accompanying drawings.

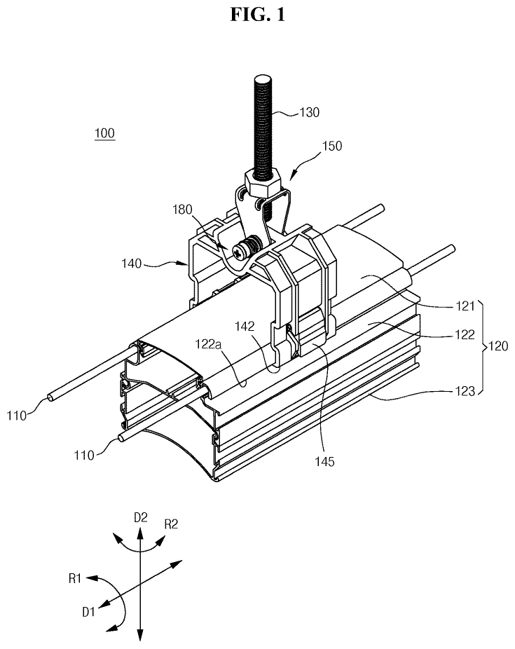

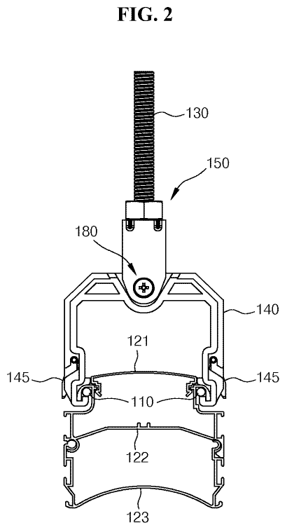

FIG. 1 is a perspective view of a duct hanger for vibration control according to one embodiment of the present invention and FIG. 2 is a front view of the duct hanger shown in FIG. 1.

As an object supported by a duct hanger 100 for vibration control according to one embodiment of the present invention, ducts 120 will be first described.

The ducts 120 may have the same cross-section, may be elongated along a longitudinal direction thereof, and may have wiring spaces therein. Each of the ducts 120 may include a base 122, a top cover 121, and a bottom cover 123.

The base 122 may have an upper wiring space formed in a U-shaped cross-sectional shape and may be provided with a pair of wire hangers 122a at right and left sides thereof with respect to the longitudinal direction thereof.

The top cover 121 may be detachably coupled to an upper end of the base 122 and may open or close the upper wiring space.

The bottom cover 123 may be detachably coupled to a lower end of the base 122 and may have a lower wiring space formed in a U-shaped cross-sectional shape.

Such ducts 120 may be supported not only by a duct hanger 100 for vibration control according to the present invention but also by wires 110.

The wire 110 may extend in the longitudinal direction of the duct 120 and may be coupled at both ends thereof to a support frame (not shown).

The wire 110 may be provided as a pair corresponding to a pair of wire hangers 122a formed at the right and left sides of the base 122.

As such, the duct 120 can have a basic vibration damping effect through the support structure of the pair of wires 110. That is, the pair of wires 110 disposed parallel to each other can damp vibration of the duct 120 in a vertical direction D2 and in a lateral direction.

When the duct 120 is supported only by the wires 110, excessive swaying of the duct 120 can occur due to bouncing of the wires 110 upon generation of external force, such as vibration. Accordingly, the duct 120 disposed in a suspension form requires an additional hanger structure to secure positional stability.

Next, a duct hanger for vibration control according to an embodiment of the present invention will be described.

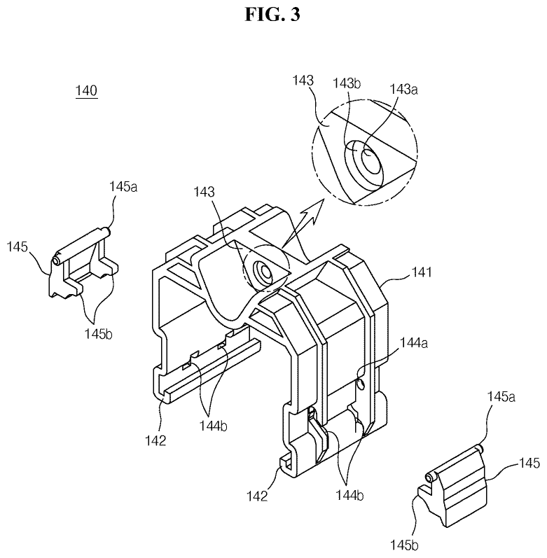

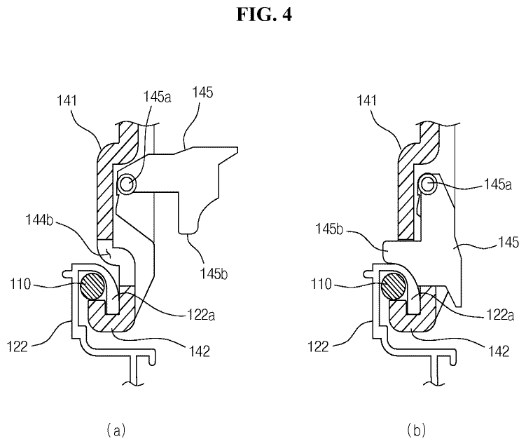

FIG. 3 is an exploded perspective view of a holder shown in FIG. 1 and FIG. 4 is side sectional views of a holding clip in operation.

Referring to FIG. 1 to FIG. 4, a duct hanger 100 for vibration control according to one embodiment may include a rod 130, a holder 140, and a connector 150.

The rod 130 may be coupled at an upper end thereof to the ceiling structure. The rod 130 may extend in a vertical direction and may be formed with threads on an outer circumferential surface thereof. An adjuster 170 may be screwed to the rod 130.

The holder 140 may be coupled to the duct 120 and may include a holder body 141 and holding clips 145.

The holder body 141 may be formed in an inverted U-shape to wrap around an upper portion of the duct 120.

The holder body 141 may be provided at lower ends of the right and left sides thereof with a pair of grippers 142 each configured to clamp both the wire hanger 122a of the duct 120 and the wire 110. When the holder body 141 is moved toward the duct 120, the grippers 142 can naturally ride over the curved wire hangers 122a of the duct 120 and then clamp both the wire hangers 122a and the wires 110.

In addition, the holder body 141 may be formed at the right and left sides thereof with pin coupling holes 144a and slots 144b. A pin 145a of the holding clip 145 may be rotatably coupled to the pin coupling hole 144a. The slot 144b is formed to allow a pressing end 145b of the holding clip 145 to pass therethrough.

Further, the holder body 141 may be formed at an upper end thereof with a boss 143 to which the connector 150 is coupled. The boss 143 may have a shaft hole 143a formed therethrough in a longitudinal direction of the duct 120 and may be formed with a first contact surface 143b, which faces a first friction member 183, on one side surface thereof in which the shaft hole 143a is formed. A first friction surface 183a of the first friction member 183 may be brought into close contact with the first contact surface 143b. Here, the first contact surface 143b may be recessed in a stepped shape corresponding to the shape of the first friction surface 183a on the one surface of the boss 143.

Each of the holding clips 145 may be detachably coupled to the holder body 141. The holding clip 145 may include the pin 145a rotatably coupled to the pin coupling hole 144a and the pressing end 145b configured to press the wire hanger 122a after passing through the slot 144b.

Referring to (a) of FIG. 4, before coupling the holder body 141 to the duct 120, the holding clip 145 may be rotated in the counterclockwise direction about the pin 145a to maintain the pressing end 145b spaced apart from the holder body 141.

Referring to (b) of FIG. 4, when the holding clip 145 is rotated in the clockwise direction about the pin 145a after coupling the holder body 141 to the duct 120, the pressing end 145b may be brought into close contact with an outer surface (side surface and upper surface) of the wire hanger 122a of the duct 120 after passing through the slot 144b of the holder body 141. As a result, the wire hanger 122a and the wire 110 can be prevented from being separated in a downward direction by the gripper 142 of the holder body 141 and prevented from being separated in an upward direction by the pressing end 145b of the holding clip 145.

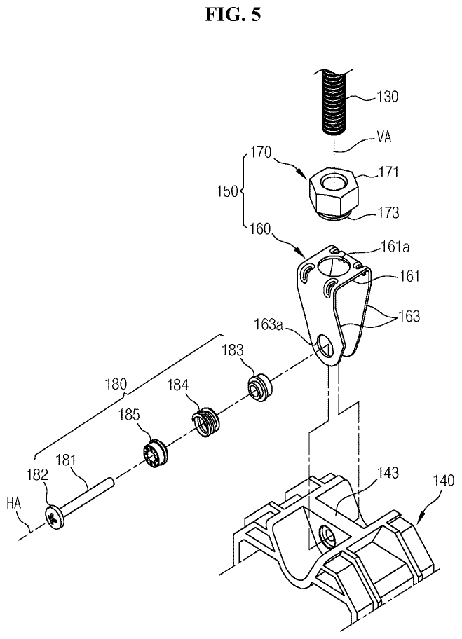

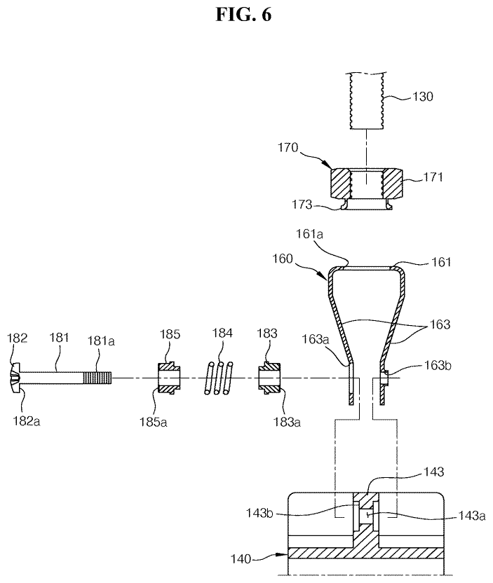

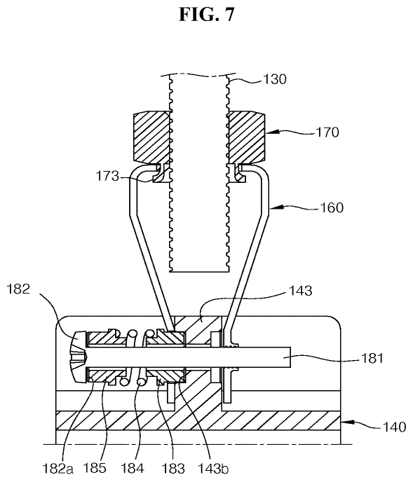

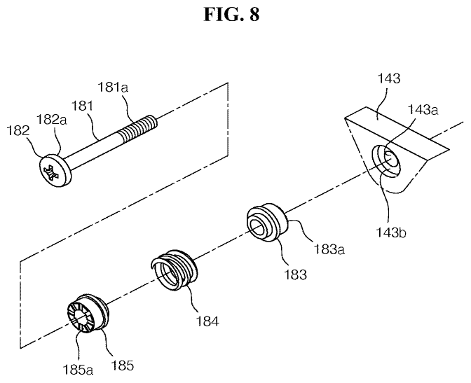

FIG. 5 is a partially exploded perspective view of the duct hanger shown in FIG. 1; FIG. 6 is an exploded sectional view of the duct hanger shown in FIG. 5; FIG. 7 is a side sectional view of the duct hanger shown in FIG. 6 in a coupled state; and FIG. 8 is a partially exploded view of the duct hanger shown in FIG. 5

Referring to FIG. 5 to FIG. 8, the connector 150 may rotatably connect the rod 130 and the holder 140 such that the rod 130 and the holder 140 can be rotated about a rotational axis HA parallel to the duct 120 by the connector 150.

The connector 150 may include a vibration damping portion 180 configured to damp vibration transmitted from the rod 130 to the holder 140 or from the holder 140 to the rod 130. The vibration damping portion 180 will be described below.

The connector 150 may further include a connection member 160 and an adjuster 170.

The connection member 160 may be rotatably coupled at a lower end thereof to the boss 143 about the rotational axis HA. The connection member 160 may be formed with an inverted U-shaped cross-sectional shape and may include a connection member top plate 161 and a connection member side plate 163.

The connection member top plate 161 may be horizontally disposed and may be rotatably coupled to the adjuster 170 about a vertical axis VA passing through a center of the rod 130. The connection member top plate 161 may have a coupling hole 161a into which an undercut 173 formed on the adjuster 170 is press fitted.

The connection member side plate 163 extends downwards from the connection member top plate 161 toward the boss 143 and may be rotatably coupled to the boss 143 about the rotational axis HA. The connection member side plate 163 may include a first connection member side plate and a second connection member side plate.

The first connection member side plate may extend from one side of the connection member top plate 161 toward one side of the boss 143 and may have a through-hole 163a coaxial with the shaft hole 143a of the boss 143 (corresponding to the rotational axis HA). The through-hole 163a may guide movement of the first friction member 183 in a direction of the rotational axis HA.

The second connection member side plate may extend from the other side of the connection member top plate 161 toward the other side of the boss 143 and may have a fastening hole 163b coaxial with the shaft hole 143a in the boss 143 (corresponding to the rotational axis HA). The fastening hole 163b may be formed with threads on an inner surface thereof such that the shaft member 181 can be screwed to the fastening hole 163b.

The adjuster 170 may connect an upper end of the connection member 160 to the rod 130 and may include an adjuster body 171 and the undercut 173.

The adjuster body 171 may have a through-hole through which the rod 130 passes. The through-hole may have a thread on an inner surface thereof. As the adjuster body 171 is screwed to the rod 130, the adjuster body 171 can be moved on the rod 130 in an upward or downward direction D2, whereby an installation height of the connection member 160 and the holder 140 can be adjusted.

The undercut 173 may be formed in a ring shape about the vertical axis VA passing through the center of the rod 130 and may protrude downwards from a lower surface of the adjuster body 171. A lower end of the undercut 173 may extend outwards in a bent shape in a radial direction about the vertical axis VA. The undercut 173 may be press-fitted into the coupling hole 161a of the connection member top plate 161 to be caught by and supported on a lower surface of the coupling hole 161a.

The vibration damping portion 180 may connect the connection member side plate 163 to the boss 143 and may include a shaft member 181, a head 182, a first friction member 183, an elastic member 184, and a second friction member 185.

The shaft member 181 may form the rotational axis HA. That is, a centerline of the shaft member 181 may coincide with the rotational axis HA. In addition, the shaft member 181 may be formed at one end thereof with a threaded portion 181a. The threaded portion 181a may be screwed to the fastening hole 163b formed in the second connection member side plate after sequentially passing through the through-hole 163a and the shaft hole 143a.

The head 182 may be coupled to the other end of the shaft member 181 and may have a second contact surface 182a that faces the second friction member 185.

The first friction member 183 may be movably coupled to the shaft member 181 in the direction of the rotational axis HA, which corresponds to the longitudinal direction of the shaft member 181, and may have the first friction surface 183a facing the first contact surface 143b of the boss 143. The first friction surface 183 may be moved toward the boss 143 by elastic force of the elastic member 184 such that the first friction surface 183a can be brought into close contact with the first contact surface 143b of the boss 143. The first friction surface 183a may be formed with irregularities to increase friction against the first contact surface 143b.

The elastic member 184 may be coupled to the shaft member 181 so as to be disposed between the head 182 and the first friction member 183 and may elastically press the first friction member 183 toward the boss 143 such that the first friction surface 183a can be brought into close contact with the first contact surface 143b. The first friction surface 183a can be brought into close contact with the first contact surface 143b with a certain magnitude of friction force by the elastic member 184.

Furthermore, depending on the degree of screw engagement between the threaded portion 181a and the fastening hole 163b of the shaft member 181, the friction force between the first friction surface 183a and the first contact surface 143b can vary. That is, when the elastic member 184 is compressed by rotating the shaft member 181 in one direction, the first friction surface 183a is brought into close contact with the first contact surface 143b with strong force, whereby strong friction force can be generated upon rotation of the first friction surface 183 and the boss 143 relative to each other. In addition, when the elastic member 184 is stretched by rotating the shaft member 181 in a reverse direction, the first friction surface 183a is brought into close contact with the first contact surface 143b with weak force, whereby weak friction force can be generated upon rotation of the first friction surface 183 and the boss 143 relative to each other.

The second friction member 185 may be movably coupled to the shaft member 181 between the head 182 and the elastic member 184 in the longitudinal direction and may have the second friction surface 185a facing the second contact surface 182a of the head 182. The second friction surface 185 may be moved toward the head 182 by elastic force of the elastic member 184 to be brought into close contact with the second contact surface 182a of the head 182. The second friction surface 185a may be formed with irregularities to increase friction against the second contact surface 182a.

If external force, such as vibration, is transmitted to the rod 130 to generate rotational force causing rotation (R1: see FIG. 1) of the rod 130 about the rotational axis HA, the connection portion 150 coupled to the rod 130, the shaft member 181 screwed to the connection portion 150, and the head 182 rotate (R1) in conjunction with each other. Here, since the second friction surface 182a of the second friction member 185 is brought into close contact with the second contact surface 182a of the head 182 by elastic force, slipping motion between the second contact surface 182a and the second friction surface 185a can be realized. As a result, displacement of the rod 130 in the direction of rotation R1 can be damped and dissipated in the vibration damping portion 180 instead of being transmitted to the holder 140.

In addition, when external force, such as vibration, is transmitted to the duct 120 to generate rotational force causing rotation (R1, see FIG. 1) of the holder 140 about the rotational axis HA, the boss 143 of the holder 140 rotates (R1). Here, since the first friction surface 183a of the first friction member 183 is brought into close contact with the first contact surface 143b of the boss 143 by elastic force, slipping motion between the first contact surface 143b and the first friction surface 183a can be realized. As a result, displacement of the duct 120 in the direction of rotation R1 can be damped and dissipated in the vibration damping portion 180 instead of being transmitted to the rod 130.

Furthermore, when external force, such as vibration, is transmitted to the rod 130 to generate rotational force causing rotation (R2, see FIG. 1) of the rod 130 about the vertical axis (VA), the adjuster 170 screwed to the rod 130 rotates (R2) in conjunction therewith. Since the coupling hole 161a of the connection member 160 is rotatably coupled to the undercut 173 of the adjuster 170, slipping motion between the adjuster 170 and the connection member 160 can be realized. As a result, displacement of the rod 130 in the direction of rotation R2 cannot be transmitted the holder 140. Similarly, even when external force, such as vibration, is transmitted to the duct 120 to generate rotational force causing rotation (R2: see FIG. 1) of the holder 140 about the vertical axis VA of the rod 130, the coupling hole 161a of the connection member 160 is rotatably coupled to the undercut 173 of the adjuster 170, whereby the displacement of the duct 120 in the direction of rotation R2 cannot be transmitted to the rod 130.

Furthermore, even when external force, such as vibration, is transmitted to the rod 130 or the duct 120 to cause displacement of the rod 130 or the duct 120 in the direction of the rotational axis HA, which corresponds to the longitudinal direction of the duct 120 (D1, see FIG. 1), the first friction member 183 in close contact with the boss 143 and the second friction member 185 in close contact with the head 182 are elastically pressed in the longitudinal direction D1 of the duct 120 by the elastic member 184, whereby the displacement of the rod 130 or the duct 120 in the longitudinal direction R2 can be damped and dissipated in the vibration damping portion 180 instead of being transmitted to the duct 120 or the rod 130.

Since friction force between the first friction surface 183a and the first contact surface 143b and friction force between the second friction surface 185a and the second contact surface 182a can be regulated by compressing or stretching the elastic member 184 by adjusting the location of the shaft member 181 screwed to the connection member 160, it is possible to effectively cope with various vibration characteristics transmitted from the outside through adjustment of damping characteristics of the vibration damping portion 180.

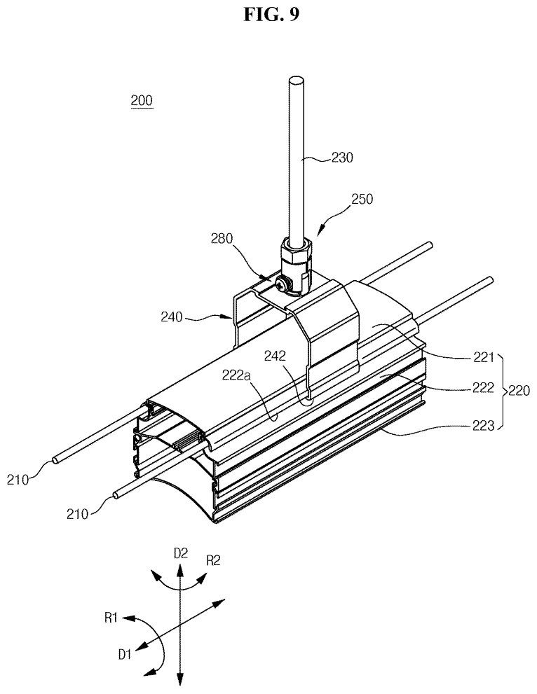

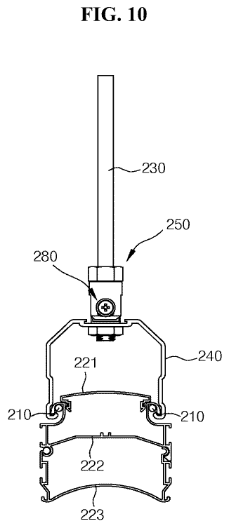

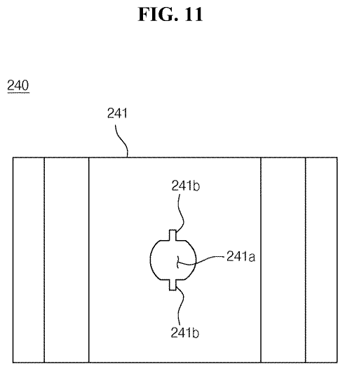

FIG. 9 is a perspective view of a duct hanger for vibration control according to another embodiment of the present invention, FIG. 10 is a front view of the duct hanger shown in FIG. 9, and FIG. 11 is a plan view of a holder shown in FIG. 9.

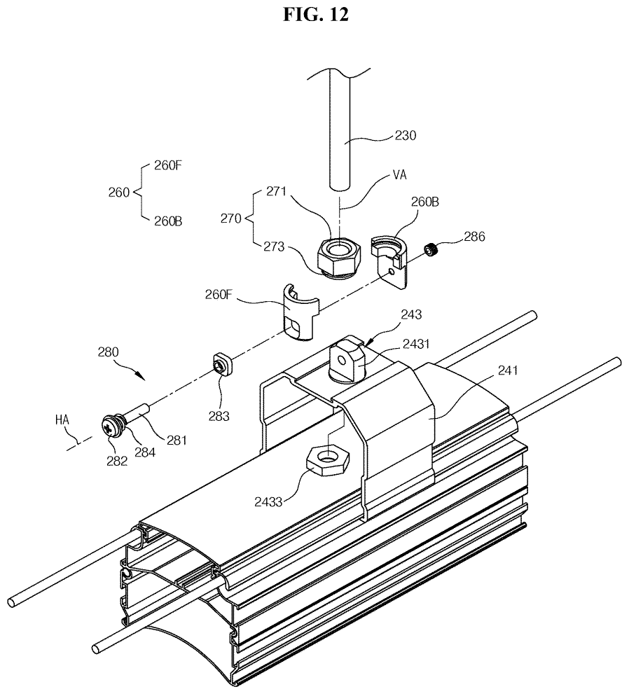

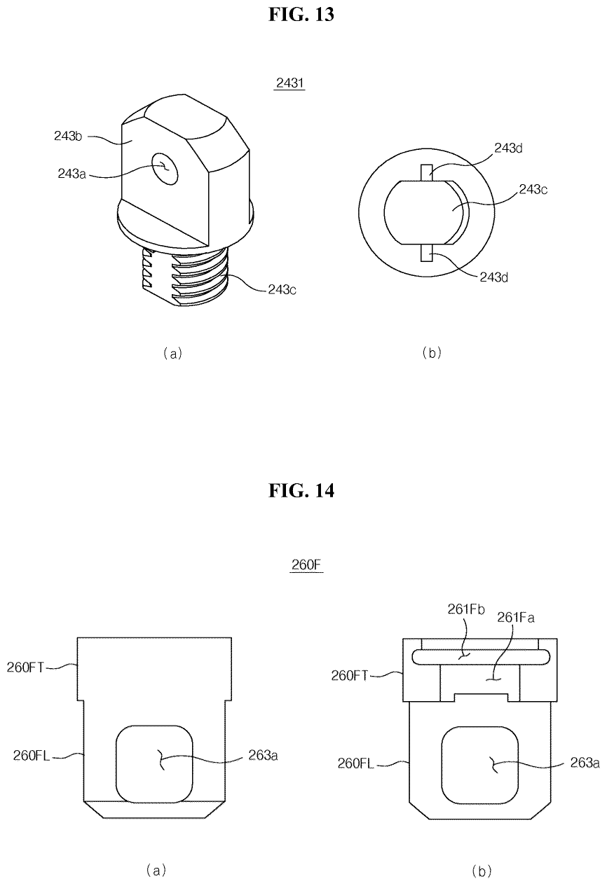

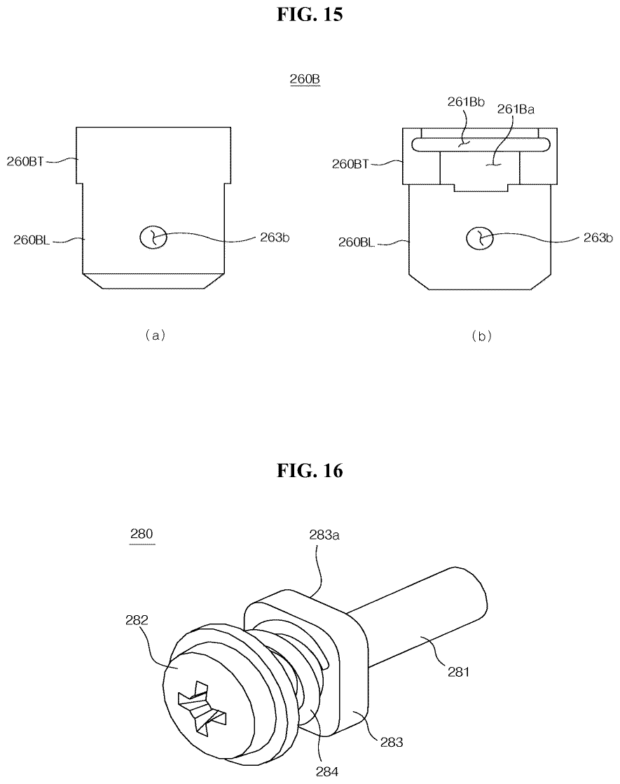

FIG. 12 is an exploded perspective view of the duct hanger shown in FIG. 9, FIG. 13 is a perspective view and a bottom view of a boss shown in FIG. 9, FIG. 14 is a front view and a rear view of a first connection member shown in FIG. 12, FIG. 15 is a front view and a rear view of a second connection member shown in FIG. 12, and FIG. 16 is a view of a vibration damping portion in a coupled state shown in FIG. 12.

Referring to FIG. 9 to FIG. 16, a duct hanger 200 for vibration control according to another embodiment of the present invention may also include a rod 230, a holder 240, and a connector 250.

The duct hanger 200 for vibration control according to this embodiment is different from the duct hanger 100 for vibration control described above in the configuration of the holder 240 and the connector 250. The following description will focus on differences therebetween and description of the same configuration as the first embodiment will be minimized.

The rod 230 may be coupled at an upper end thereof to the ceiling structure. The rod 230 may extend in a vertical direction and may be formed with threads on an outer circumferential surface thereof. An adjuster 270 may be screwed to the rod 230.

The holder 240 may be coupled to the duct 120 and may include a holder body 241 and a boss 243.

Although the holder according to the above embodiment includes the holder body and the boss as a single body, the holder 240 according to this embodiment may include the holder body 241 and the boss 243 detachable from each other.

Specifically, as shown in FIG. 13, the holder body 241 may have a boss coupling hole 241a formed through an upper end thereof. The boss coupling hole 241a may be formed in a shape corresponding to the shape of a threaded portion 243c of the boss 243 such that the threaded portion 243c of the boss 243 passes through the boss coupling hole 241a. In addition, the boss coupling hole 241a may be formed with positioning grooves 241b into which positioning protrusions 243d of the boss 243 are inserted.

The boss 243 may include a boss body 2431 and a boss fixture 2433.

The boss body 2431 may have a shaft hole 243a formed therethrough in the longitudinal direction of the duct 120 and may be formed with a first contact surface 243b, which faces the first friction member 283, on one side surface of the boss 243 in which the shaft hole 243a is formed. A first friction surface 283a of the first friction member 283 may be brought into close contact with a first contact surface 243b. In addition, the boss body 2431 may be provided at a lower end thereof with the threaded portion 243c, which may be screwed to the boss fixture 2433 through the boss coupling hole 241a of the holder body 241. Further, the boss body 2431 may include the positioning protrusions 243d that protrude from the periphery of the threaded portion 243c in a radial direction. When the boss body 2431 is coupled to the boss coupling hole 241a, a coupling position of the boss body 2431 can be naturally set as the positioning protrusions 243d are inserted into the positioning grooves 241b. That is, the boss body 2431 may be disposed such that the shaft hole 243a and the first contact surface 243b of the boss body 2431 face in the direction of the rotational axis HA, which corresponds to the longitudinal direction of the duct 120.

The boss fixture 2433 is disposed at an opposite side of the boss body 2431, with the boss coupling hole 241a disposed therebetween, and may be screwed to the threaded portion 243c of the boss body 2431, which penetrates the boss coupling hole 241a.

The connector 250 may include a vibration damping portion 280 configured to damp vibration transmitted from the rod 230 to the holder 240 or from the holder 240 to the rod 230.

The connector 250 may further include a connection member 260 and an adjuster 270.

The connection member 260 may be rotatably coupled at a lower end thereof to the boss 243 about the rotational axis HA and at an upper end thereof to the adjuster 270 about the vertical axis VA.

The connection member according to the above embodiment is a one-piece body, whereas the connection member 260 according to this embodiment has a structure that a front connection member 260F and a rear connection member 260B are separable.

Specifically, the front connection member 260F may have an upper front connection portion 260FT formed at an upper end thereof and a lower front connection portion 260FL formed at a lower end thereof.

The upper front connection portion 260FT may have a front through-groove 261Fa through which the rod 230 passes, and a front coupling groove 261Fb into which the undercut 273 of the adjuster 270 is inserted and supported thereby.

The lower front connection part 260FL may have a front through-hole 263a through which the shaft member 281 of the vibration damping portion 280 and the first friction member 283 pass. The front through-hole 263a may be formed in a shape corresponding to the shape of the first friction member 283.

The rear connection member 260B may have an upper rear connection portion 260BT formed at an upper end thereof and a lower rear connection portion 260BL formed at a lower end thereof.

The upper rear connector 260BT may have a rear through-groove 261Ba through which the rod 230 passes, and a rear coupling groove 261Bb into which the undercut 273 of the adjuster 270 is inserted and supported thereby.

The lower rear connection portion 260BL may have a rear through-hole 263b through which the shaft member 281 of the vibration damping portion 280 passes. The shaft member 281 may be screwed to a securing member 286 through the rear through-hole 263b. As in the above embodiment, the securing member 286 may be integrally formed with the connection member 260.

When the front coupling groove 261Fb and the rear coupling groove 261Bb of the connection member 260 are coupled to each other, the connection member 260 can be rotated away from the adjuster 270 about the vertical axis VA as the front coupling groove 261Fb and the rear coupling groove 261Bb are coupled to the undercut 273 of the adjuster 270.

The adjuster 270 may connect an upper end of the connection member 260 to the rod 230 and may include an adjuster body 271 and the undercut 273.

The adjuster body 271 may have a through-hole through which the rod 230 passes. The through-hole may have threads on an inner surface thereof. As the adjuster body 271 is screwed to the rod 230, the adjuster body 271 can be moved on the rod 230 in an upward or downward direction D2, whereby an installation height of the connection member 260 and the holder 240 can be adjusted.

The undercut 273 may be formed in a ring shape about a vertical axis VA passing through the center of the rod 230 and may protrude downwards from a lower surface of the adjuster body 271. A lower end of the undercut 273 may extend outwards in a bent shape in a radial direction about the vertical axis VA. The undercut 273 may be rotatably coupled to the front coupling groove 261Fb and the rear coupling groove 261Bb about the vertical axis VA upon engagement of the front connection member 260F and the rear connection member 260B.

The vibration damping portion 280 may connect the connection member 260 to the boss 243 and may include a shaft member 281, a head 282, a first friction member 283, and an elastic member 284.

The shaft member 281 may form the rotational axis HA. That is, a centerline of the shaft member 281 may coincide with the rotational axis HA. In addition, the shaft member 281 may be formed at one end thereof with a threaded portion. The threaded portion may be screwed to the securing member 286 after sequentially passing through the front through-hole 263a, the shaft hole 243a, and the rear through-hole 263b.

The head 282 may be coupled to the other end of the shaft member 281 and may support the elastic member 284 in a direction of the boss 243.

The first friction member 283 may be movably coupled to the shaft member 281 in the direction of the rotational axis HA, which corresponds to the longitudinal direction of the shaft member 281, and may have a first friction surface 283a facing the first contact surface 243b of the boss 243. The first friction surface 283 may be moved toward the boss 243 by elastic force of the elastic member 284 such that the first friction surface 283a can be brought into close contact with the first contact surface 243b of the boss 243. The first friction surface 283a may be formed with irregularities to increase friction against the first contact surface 243b.

The elastic member 284 may be coupled to the shaft member 281 so as to be disposed between the head 282 and the first friction member 283 and may elastically press the first friction member 283 toward the boss member 243 such that the first friction surface 283a can be brought into close contact with the first contact surface 243b. The first friction surface 283a can be brought into close contact with the first contact surface 243b with a certain magnitude of friction force by the elastic member 284.

Furthermore, depending on the degree of screw engagement between the shaft member 281 and the securing member 286, the friction force between the first friction surface 283a and the first contact surface 243b can vary. That is, when the elastic member 284 is compressed by rotating the shaft member 281 in one direction, the first friction surface 283a is brought into close contact with the first contact surface 243b with strong force, whereby strong friction force can be generated upon rotation of the first friction surface 283 and the boss 243 relative to each other. In addition, when the elastic member 284 is stretched by rotating the shaft member 281 in the reverse direction, the first friction surface 283a is brought into close contact with the first contact surface 243b with weak force, whereby weak friction force can be generated upon rotation of the first friction surface 283 and the boss 243 relative to each other.

As such, the duct hangers 100; 200 for vibration control according to the present invention can be consistently installed at a predetermined location and are capable of effectively damping vibration caused by external force through the connector configured to rotatably connect the rod to the holder and including the vibration damping portion.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention. For example, components described as implemented separately may also be implemented in combined form, or vice versa.

The scope of the present invention is indicated by the following claims and all changes or modifications derived from the meaning and scope of the claims and equivalents thereto should be construed as being within the scope of the present invention.

### LIST OF REFERENCE NUMERALS

100, 200: Duct hanger for vibration control
110: Wire
120: Duct
130: Rod
140: Holder
143: Boss
150: Connector
160: Connection member
161: Connection member top plate
163: Connection member side plate
170: Adjuster
171: Adjuster body
173: Undercut
180: Vibration damping portion
181: Shaft member
182: Head
183: First friction member
185: Second friction member
184: Elastic member

1. A duct hanger for vibration control comprising:
a rod coupled to the ceiling;
a holder coupled to the duct; and
a connector rotatably connecting the rod and the holder about a rotational axis parallel to the duct,
wherein the connector comprises a vibration damping portion configured to damp vibration transmitted from the rod or the holder.

2. The duct hanger for vibration control according to claim 1, wherein the connector comprises:
a connection member rotatably coupled to a boss of the holder about the rotational axis; and
an adjuster connecting the connection member and the rod and screwed to the rod to allow an installation height of the connection member to be adjusted.

3. The duct hanger for vibration control according to claim 2, wherein the connection member comprises a connection member top plate rotatably coupled to the adjuster about a vertical axis passing through a center of the rod and a connection member side plate extending from the connection member top plate toward the boss and rotatably coupled to the boss about the rotational axis.

4. The duct hanger for vibration control according to claim 3, wherein the connection member top plate has a coupling hole into which an undercut formed on the adjuster is press-fitted.

5. The duct hanger for vibration control according to claim 3, wherein the connection member side plate comprises:
a first connection member side plate extending from one side of the connection member top plate toward one side of the boss and having a through-hole coaxial with a shaft hole formed in the boss; and
a second connection member side plate extending from the other side of the connection member top plate toward the other side of the boss and having a fastening hole coaxial with the shaft hole formed in the boss.

6. The duct hanger for vibration control according to claim 1, wherein the vibration damping portion comprises:
a shaft member forming the rotational axis;
a friction member movably coupled to the shaft member in a longitudinal direction of the shaft member and having a friction surface facing a contact surface of the boss formed on the holder; and
an elastic member elastically pressing the friction member towards the boss such that the friction surface is brought into close contact with the contact surface.

7. The duct hanger for vibration control according to claim 5, wherein the vibration damping portion comprises:
a shaft member forming the rotational axis and having a threaded portion at one end thereof, the threaded portion being screwed to the fastening hole after passing through the through-hole and the shaft hole;
a head coupled to the other end of the shaft member;
a first friction member movably coupled to the shaft member in a longitudinal direction of the shaft member and having a first friction surface facing the contact surface of the boss; and
an elastic member coupled to the shaft member to be disposed between the head and the first friction member, the elastic member elastically pressing the first friction member toward the boss such that the first friction surface is brought into close contact with the contact surface,
wherein friction force between the contact surface and the first friction surface varies depending on a degree of screw engagement between the threaded portion and the fastening hole.

8. The duct hanger for vibration control according to claim 7, wherein the vibration damping portion further comprises a second friction member movably coupled to the shaft member in the longitudinal direction of the shaft member between the head and the elastic member and having a second friction surface facing the contact surface of the head.
